(19) United States
(12) Patent Application Publication
(10) Pub. No.: US 2011/0043138 A1
(43) Pub. Date: Feb. 24, 2011

(54) Light Emitting Device Capable of Dynamically Regulating Output Voltage and Related Control Method

(76) Inventors: Kuo-Ching Hsu, Hsinchu City (TW); Tsung-Hau Chang, Hsinchu City (TW); Chin-Hsun Hsu, Taipei County (TW); Ting-Wei Liao, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/647,384

(22) Filed: Dec. 24, 2009

(30) Foreign Application Priority Data
Aug. 24, 2009 (TW) 098128369

(51) Int. Cl. H05B 41/36

(52) U.S. Cl. 315/297

(57) ABSTRACT

A light-emitting diode (LED) device capable of dynamically regulating output voltage is disclosed. The LED device includes a plurality of LED chains, a voltage converter, a current driving unit, a loop control unit. The loop control unit is coupled to the LED chains and the voltage converter, and includes a voltage selection unit, an error amplifier, and a conversion controller. The voltage selection unit is utilized for generating a plurality of candidate voltages according to a threshold voltage and a plurality of headroom voltage voltages corresponding to the LED chains and the current driving unit, and selecting a feedback voltage from the candidate voltages. The error amplifier generates an error voltage signal according to a reference voltage and the feedback voltage. The conversion controller generates a voltage control signal according to the error voltage signal to control the voltage conversion of the voltage converter.

### BACKGROUND OF THE INVENTION

1. Field of the Invention

The present invention relates to a light emitting device and related control method, and more particularly, to a light emitting device capable of dynamically regulating output voltage and related control method.

2. Description of the Prior Art

Compared with conventional light source devices, light emitting diodes (LEDs) offer advantages of energy savings, long device lifetime, no mercury used, high achievable color gamut, without idle time, and fast response speed, so that LED technology is widely applied in fields of display and illumination. For example, cold cathode fluorescent lamps (CCFLs) are conventionally used as a light source in a backlight module of a liquid crystal display. However, LEDs have gradually replaced CCFLs as the light source of the backlight module due to continuously rising luminous efficiency and decreasing cost.

However, forward voltages of various LEDs are different due to the effect of the fabrication process variations and material purity. Therefore, headroom voltages across current driving devices on each driving current path may be different. Please refer to FIG. 1, which is a schematic diagram of an LED driving device 10 according to the prior art. The LED driving device 10 is utilized for driving a plurality of LED chains C₁ to Cₘ arranged in parallel, and each LED chain includes n LEDs in each LED chain. The LED driving device 10 includes a voltage converter 102, a current driving unit 104, and a control unit 106. The voltage converter 102 is utilized for providing an output voltage V_{D} to the LED chains C₁ to Cₘ. The current driving unit 104 is utilized for providing driving currents I_{D1} to I_{DM} to drive the LED chains C₁ to Cₘ. In general, a plurality of headroom voltages V_{HR1} to V_{HRm} exist on each path of the LED chains C₁ to Cₘ. The headroom voltages V_{HR1} to V_{HRm} represent the voltage value across the current driving unit 104 on each path of the LED chains C₁ to Cₘ, i.e. available voltage value for the current driving unit 104 on each LED chain path. In practice, the voltages across the LEDs may not be all the same due to above mentioned factors, so that the headroom voltages V_{HR1} to V_{HRM} are not the same correspondingly. In such a condition, the headroom voltage may be too high or too low, and will result in some unwanted effects. For example, if the headroom voltage is too high, the power consumption of the current driving unit will increase, and the power conversion efficiency will be reduced. If the headroom voltage is not high enough, the current driving unit will operate in an improper state, and cannot keep constant current sink, even to the point of not being able to provide the required driving current to the LED, and the LED will not conduct.

Therefore, as shown in FIG. 1, in the conventional technology, the voltage converter 102 may be controlled to change the output voltage V_{D} by the control unit 106 in a negative feedback form in order to obtain enough headroom voltages on the current driving unit for keeping current sink operation. The control unit 106 includes a minimum voltage selector 108, an error amplifier 110, and a conversion controller 112. The minimum voltage selector 108 is coupled to the negative electrodes of the LED chains C₁ to Cₘ for selecting a minimum voltage from the headroom voltages V_{HR1} to V_{HRM} as a feedback voltage V_{FB}. The error amplifier 110 receives the feedback voltage V_{FB} and a reference voltage V_{REF} via a negative terminal and a positive terminal of the error amplifier 110 correspondingly, and generates an error voltage signal S_{E} according to the difference between the feedback voltage V_{FB} and the reference voltage V_{REF}. The conversion controller 112 generates a voltage control signal S_{C} according to the error voltage signal S_{E} in order to control the voltage converter 102 to rise or decrease the output voltage V_{D}. Thus, through the control unit 106, the voltage converter 102 can provide an appropriate output voltage V_{D} to lock the headroom voltages within a sensible value, i.e. the reference voltage V_{REF}, for allowing the current driving unit to provide sufficient driving current.

Please refer to FIG. 2, which is a schematic diagram of a minimum voltage selector 108 shown in FIG. 1 according to the prior art. The minimum voltage selector 108 performs pairwise comparisons on each headroom voltage pair for all the headroom voltages V_{HR1} to V_{HRM}, and selects the lower one to provide to the next stage. A lowest headroom voltage is selected like this, finally. As shown in FIG. 2, each voltage comparison unit 202 is able to generate a control signal R to control the corresponding multiplexer 204 to output the lower headroom voltage to the next stage, in that manner, the feedback voltage V_{FB} having the lowest voltage value among the headroom voltages V_{HR1} to V_{HRM} is then obtained. However, the more LED chains that are used, the more stages of comparison operations are used in practice, resulting in the waste of more operation time and more comparison devices.

### SUMMARY OF THE INVENTION

It is therefore an objective of the present invention to provide a light emitting device capable of dynamically regulating output voltage and related control method.

The present invention discloses an LED device capable of dynamically regulating output voltage, which includes a plurality of LED chains, a voltage converter, a current driving unit, and a loop control unit. Each LED chain has a positive electrode and a negative electrode. The voltage converter is coupled to the positive electrodes of the plurality of LED chains, and is utilized for converting an input voltage to an output voltage according to a voltage control signal. The current driving unit is coupled to the negative electrodes of the plurality of LED chains, and is utilized for providing a plurality of driving currents to the plurality of LED chains to drive the plurality of LED chains. The loop control unit is coupled to the plurality of LED chains and the voltage converter, and includes a voltage selection unit, an error amplifier, and a conversion controller. The voltage selection unit is coupled to the negative electrodes of the plurality of LED chains, and is utilized for generating a plurality of candidate voltages according to a threshold voltage and a plurality of headroom voltages corresponding to the plurality of LED chains and selecting a feedback voltage from the plurality of candidate voltages. The error amplifier is coupled to the voltage selection unit, and is utilized for generating an error voltage signal according to a reference voltage and the feedback voltage. The conversion controller is coupled to the error amplifier and the voltage converter, and is utilized for generating the voltage control signal according to the error voltage signal to the voltage converter for voltage conversion.

The present invention further discloses a control method for an LED device, in which the LED device includes a plurality of LED chains, a current driving unit, and a voltage converter. Each LED chain of the plurality of LED chains has a positive electrode and a negative electrode. The voltage converter is coupled to the positive electrodes of the plurality of LED chains, and is utilized for converting an input voltage to an output voltage according to a voltage control signal. The current driving unit is coupled to the negative electrodes of the plurality of LED chains, and is utilized for providing a plurality of driving currents to the plurality of LED chains. The control method includes generating a plurality of candidate voltages according to a threshold voltage and a plurality of headroom voltages corresponding to the plurality of LED chains and selecting a feedback voltage from the plurality of candidate voltages; generating an error voltage signal according to a reference voltage and the feedback voltage; and generating the voltage control signal according to the error voltage signal to the voltage converter for voltage conversion.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an LED driving device according to the prior art.

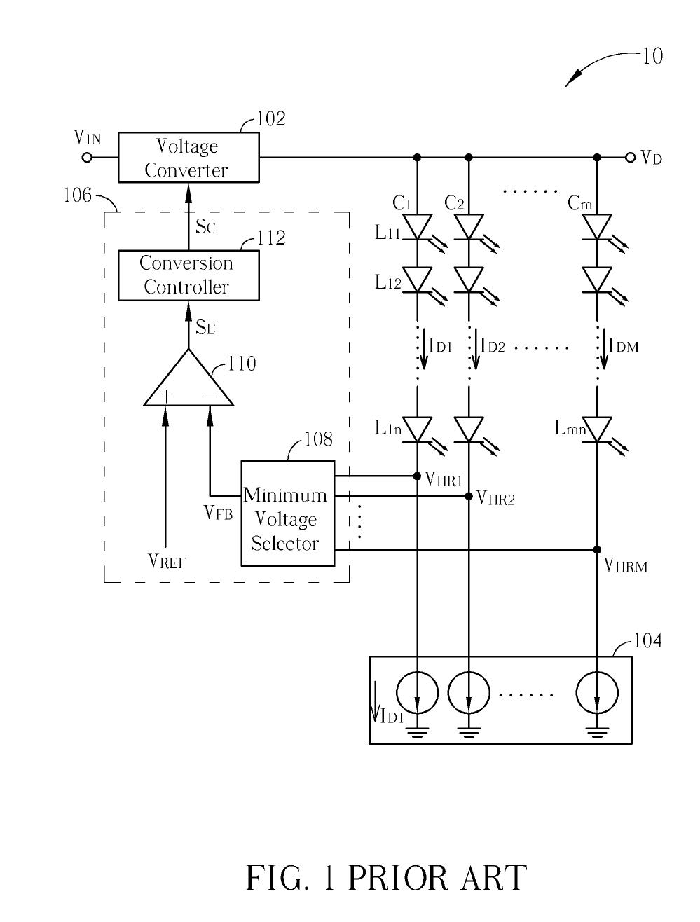

FIG. 2 is a schematic diagram of a minimum voltage selector shown in FIG. 1 according to the prior art.

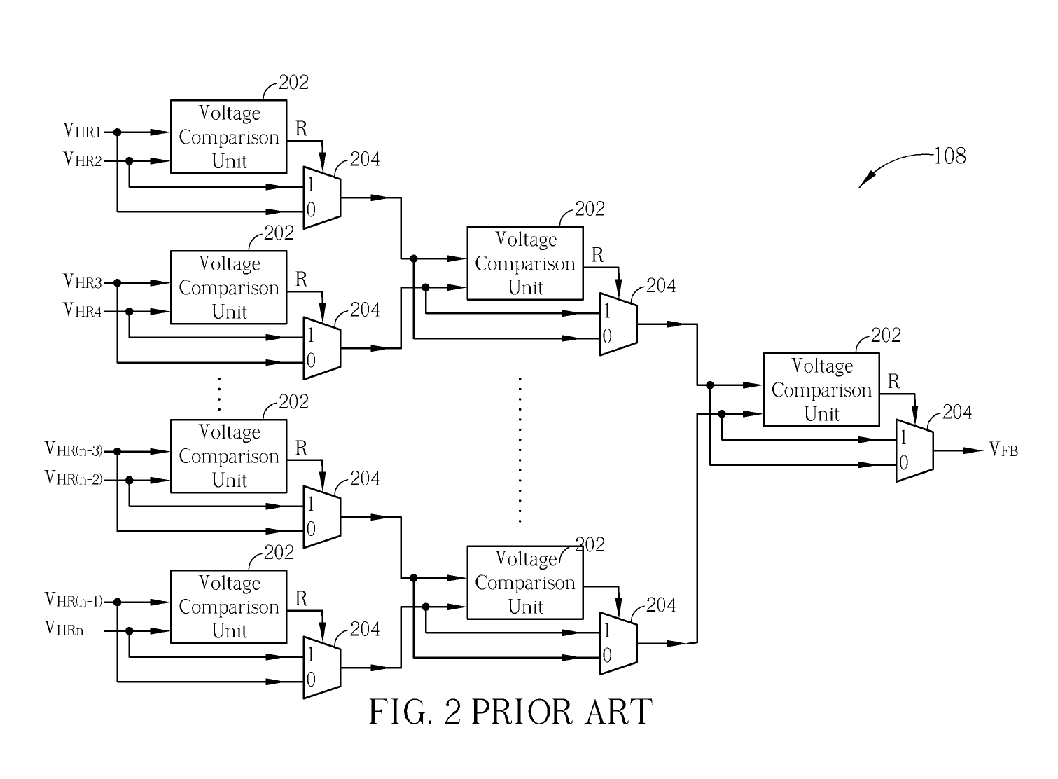

FIG. 3 is a schematic diagram of an LED device capable of dynamically regulating output voltage according to an embodiment of the present invention.

FIG. 4 is a schematic diagram of the voltage selection unit shown in FIG. 3 according to an embodiment of the present invention.

FIG. 5 is a schematic diagram of a procedure according to an embodiment of the present invention.

### DETAILED DESCRIPTION

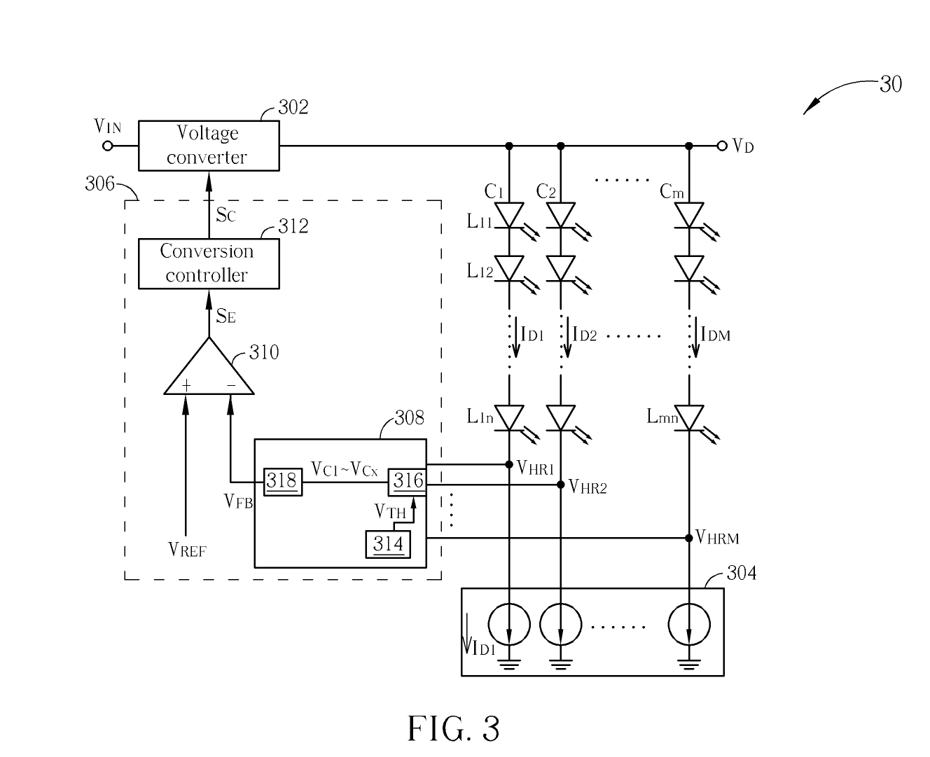

Please refer to FIG. 3, which is a schematic diagram of an LED device 30 capable of dynamically regulating output voltage according to an embodiment of the present invention. The LED device 30 can be applied to any kind of light source. The LED device 30 includes a plurality of LED chains C₁ to Cₘ, a voltage converter 302, a current driving unit 304, and a loop control unit 306. In the embodiment of the present invention, The LED device 30 includes a plurality of LED chains C₁ to Cₘ, and this should not be a limitation of the present invention. In other words, The LED device 30 can also have one LED chain only. On the other hand, since the LED is a current driven component, the brightness of the LED is proportional to the driving current. Therefore, each LED chain includes at least one LED in series, such as having n LEDs in each LED chain, and the number of the LEDs included in each LED chain must be the same in order to allow the current through each LED to be identical and result in the same brightness.

Furthermore, the voltage converter 302 is coupled to the positive electrodes of the LED chains C₁ to Cₘ for converting an input voltage V_{IN} to an output voltage V_{D} according to a voltage control signal S_{c} for the LED chains C₁ to Cₘ. The current driving unit 304 is coupled to the negative electrodes of the LED chains C₁ to Cₘ for providing a plurality of driving currents I_{D1} to I_{DM} passing through each corresponding LED chain in order to drive the LED chains C₁ to Cₘ. The loop control unit 306 is utilized for controlling the voltage converter 302 to increase or decrease the output voltage V_{D} according to a plurality of headroom voltages V_{HR1} to V_{HRM} corresponding to the LED chains C₁ to Cₘ. The loop control unit 306 includes a voltage selection unit 308, an error amplifier 310, and a conversion controller 312. The voltage selection unit 308 is coupled to the negative electrodes of the LED chains C₁ to Cₘ for generating a plurality of candidate voltages V_{C1} to V_{Cx} according to a threshold voltage V_{TH} and the headroom voltages V_{HR1} to V_{HRM} corresponding to the LED chains C₁ to Cₘ, and selecting a feedback voltage V_{FB} among the candidate voltages V_{C1} to V_{Cx}. The threshold voltage V_{TH} is a predetermined voltage value. The error amplifier 310 is coupled to the voltage selection unit 308 for generating an error voltage signal S_{E} according to a reference voltage V_{REF} and the feedback voltage V_{FB}. The conversion controller 312 is coupled to an output terminal of the error amplifier 310 and the voltage converter 302 for generating the voltage control signal S_{C} according to the error voltage signal S_{E} to inform the voltage converter 302 to increase or decrease the output voltage V_{D} accordingly. Therefore, the voltage converter 302 can convert the appropriate output voltage V_{D} in real-time.

The following further elaborates the voltage selection unit 308 shown in FIG. 3. Please further refer to FIG. 3. The voltage selection unit 308 includes a threshold voltage generation unit 314, a voltage detection unit 316, and a voltage selector 318. The threshold voltage generation unit 314 is utilized for generating the threshold voltage V_{TH}. The voltage detection unit 316 is coupled to the negative electrodes of the LED chains C₁ to Cₘ and the threshold voltage generation unit 314 for comparing the threshold voltage V_{TH} with the headroom voltages V_{HR1} to V_{HRM}, and the voltage detection unit 316 selects the candidate voltages V_{C1} to V_{Cx} being less than the threshold voltage V_{TH} from the headroom voltages V_{HR1} to V_{HRM}. The voltage selector 318 is coupled to the voltage detection unit 316 for selecting the feedback voltage V_{FB} according to the candidate voltages V_{C1} to V_{Cx}. In short, the voltage selection unit 308 is capable of choosing one voltage value, i.e. the feedback voltage V_{FB}, less than the threshold voltage V_{TH} among the headroom voltages, so that the voltage converter 302 can dynamically regulate the output voltage V_{D} accordingly.

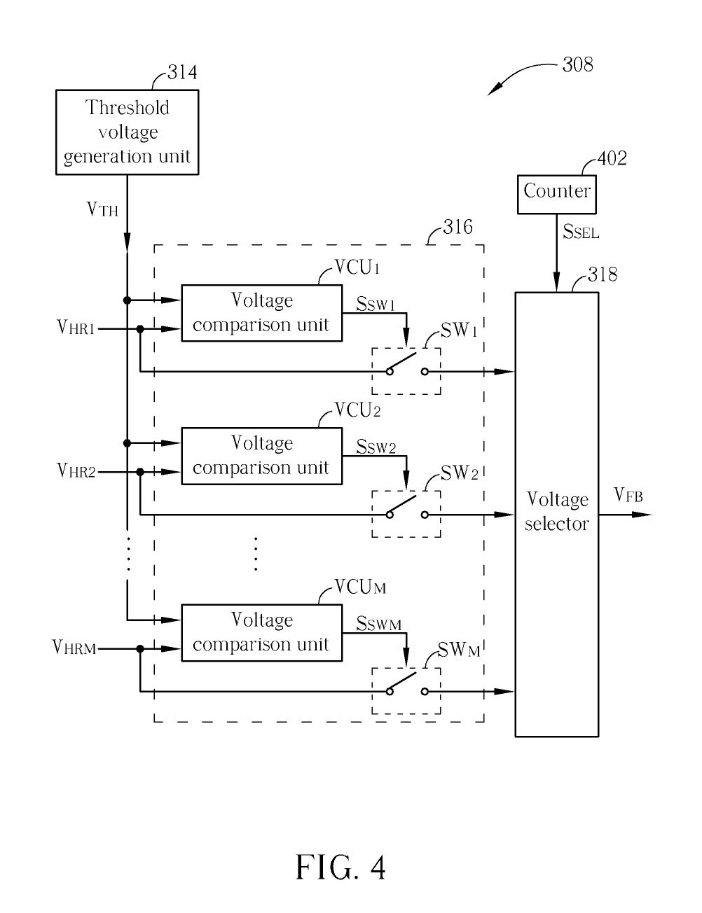

Note that, the voltage selection unit 308 is an exemplary embodiments of the present invention, and those skilled in the art can make alternatives and modifications accordingly. For example, please refer to FIG. 4, which is a schematic diagram of the voltage selection unit 308 shown in FIG. 3 according to an embodiment of the present invention. The voltage detection unit 316 includes a plurality of voltage comparison units VCU₁ to VCU_{M} and a plurality of switch units SW₁ to SW_{M}. As shown in FIG. 4, the voltage comparison units VCU₁ to VCU_{M} are coupled to the negative electrodes of the LED chains C₁ to Cₘ, respectively, and the switch units SW₁ to SW_{M} are coupled to the negative electrodes of the LED chains C₁ to Cₘ and the voltage comparison units VCU₁ to VCU_{M}. For each voltage comparison unit, when the corresponding headroom voltage is less than the threshold voltage V_{TH}, the voltage comparison unit will output a corresponding control signal S_{SW} to the corresponding switch unit. Each switch unit can output the corresponding headroom voltage as a candidate voltage according to the corresponding control signal S_{SW}. In addition, the amount of the candidate voltages selected by the voltage detection unit 316 is not a fixed amount and varies with the condition of each LED chain. Moreover, the voltage selection unit 308 further includes a counter 402 coupled to the voltage selector 318. The counter 402 is utilized for calculating the amount of the candidate voltages. When having only one candidate voltage, the counter 402 is able to generate a selection signal S_{SEL} for controlling the voltage selector 318 to select the only candidate voltage as the feedback voltage V_{FB}. In other words, when having only one candidate voltage, the counter 402 can notify the voltage selector 318, so that the voltage selector 318 can output the feedback voltage V_{FB} without performing any selection process.

Therefore, in contrast to the prior art, the present invention can real-time regulate the proper output voltage V_{D} for driving the LED chains successfully without performing multistage comparison process and consuming too many components. As for detailed operation of the LED device 30, please refer to the following description.

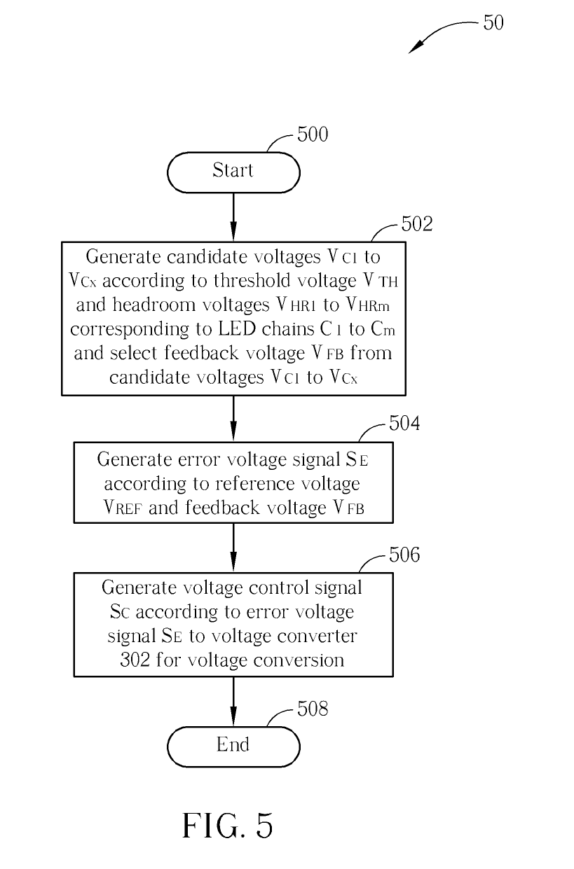

Please refer to FIG. 5, which is a schematic diagram of a procedure 50 according to an embodiment of the present invention. The procedure 50 is utilized for illustrating an operation procedure of the LED device 30 controlling the output voltage 30 through a feedback manner, which comprises the following steps:

Step 500: Start.

Step 502: Generate candidate voltages V_{C1} to V_{Cx} according to threshold voltage V_{TH} and headroom voltages V_{HR1} to V_{HRm} corresponding to LED chains C₁ to Cₘ and select feedback voltage V_{FB} from candidate voltages V_{C1} to V_{Cx}.

Step 504: Generate error voltage signal S_{E} according to reference voltage V_{REF} and feedback voltage V_{FB}.

Step 506: Generate voltage control signal S_{E} according to error voltage signal S_{E} to voltage converter 302 for voltage conversion.

Step 508: End.

According to procedure 50, the voltage detection unit 316 selects the candidate voltages V_{C1} to V_{Cx} which are less than the threshold voltage V_{TH} from the headroom voltages V_{HR1} to V_{HRM} corresponding to the LED chains C₁ to Cₘ, and provides the selected candidate voltages to the voltage selector 318. The voltage selector 318 selects the feedback voltage V_{FB} from the candidate voltages V_{C1} to V_{Cx}. Furthermore, the error amplifier 310 generates the error voltage signal S_{E} according to the reference voltage V_{REF} and the feedback voltage V_{FB}. After that, the conversion controller 312 generates the voltage control signal S_{C} according to the error voltage signal S_{E} so as to control the voltage converter 302 to increase or decrease the output voltage V_{D} accordingly.

Therefore, the present invention needs only one stage comparison procedure without performing multistage voltage comparisons to obtain the lowest headroom voltage. Also, unlike the conventional method, the present invention needs not to wait until the lowest headroom voltage is selected and further to implement the following feedback control process. As a result, the present invention can real-time regulate the proper output voltage provided by the voltage converter and reduce the hardware cost required for implementing the multiage comparison process.

On the other hand, after the voltage detection unit 316 selects all of the voltage values less than the threshold voltage V_{TH} among the headroom voltages V_{HR1} to V_{HRM} as the candidate voltages V_{C1} to V_{Cx}, preferably, the voltage selector 318 selects the feedback voltage V_{FB} in a random manner or according to a predetermined priority order from the candidate voltages V_{C1} to V_{Cx}. The said predetermined priority order can be a regular arrangement or a certain priority order. Moreover, since the feedback voltage V_{FB} is selected by the abovementioned manner, the voltage converter 302 increases the output voltage V_{D} accordingly in order to provide the current driving unit 304 enough headroom voltage for generating the driving current. Therefore, the amount of the candidate voltages V_{C1} to V_{Cx} selected by the voltage detection unit 316 will decrease with the increasing amount of the feedback processes.

In summary, the prior art requires performing a multistage voltage comparison method to obtain the lowest headroom voltage and must wait until the lowest headroom voltage is selected so as to implement the follow feedback control process. Comparatively, the present invention needs only one stage comparison procedure and can real-time regulate the proper output voltage provided by the voltage converter and reduce the hardware cost without implementing the multiage comparison process.

Those skilled in the art will readily observe that numerous modifications and alterations of the device and method may be made while retaining the teachings of the invention.

What is claimed is:

1. A light-emitting diode (LED) device capable of dynamically regulating output voltage, comprising:
a plurality of LED chains, each LED chain having a positive electrode and a negative electrode;
a voltage converter, coupled to the positive electrodes of the plurality of LED chains, for converting an input voltage to an output voltage according to a voltage control signal;
a current driving unit, coupled to the negative electrodes of the plurality of LED chains, for providing a plurality of driving currents to the plurality of LED chains to drive the plurality of LED chains; and
a loop control unit, coupled to the plurality of LED chains and the voltage converter, comprising:
a voltage selection unit, coupled to the negative electrodes of the plurality of LED chains, for generating a plurality of candidate voltages according to a threshold voltage and a plurality of headroom voltages corresponding to the plurality of LED chains and selecting a feedback voltage from the plurality of candidate voltages;
an error amplifier, coupled to the voltage selection unit, for generating an error voltage signal according to a reference voltage and the feedback voltage; and
a conversion controller, coupled to the error amplifier and the voltage converter, for generating the voltage control signal according to the error voltage signal to the voltage converter for voltage conversion.

2. The LED device of claim 1, wherein the voltage selection unit comprises:
a threshold voltage generation unit, for generating the threshold voltage;
a voltage detection unit, coupled to the negative electrodes of the plurality of LED chains and the threshold voltage generation unit, for comparing the threshold voltage with the plurality of headroom voltages to select the plurality of candidate voltages being less than the threshold voltage from the plurality of headroom voltages; and
a voltage selector, coupled to the voltage detection unit, for selecting the feedback voltage according to the plurality of candidate voltages.

3. The LED device of claim 2, wherein the voltage detection unit comprises:
a plurality of voltage comparison units, respectively coupled to the negative electrodes of the plurality of LED chains, each voltage comparison unit being utilized for outputting a control signal when the corresponding headroom voltage is less than the threshold voltage; and
a plurality of switch units, coupled to the negative electrodes of the plurality of LED chains and the plurality of voltage comparison units, each switch unit being utilized for outputting the corresponding headroom voltage according to the control signal.

4. The LED device of claim 2, wherein the voltage selector selects the feedback voltage in a random manner from the plurality of candidate voltages.

5. The LED device of claim 2, wherein the voltage selector selects the feedback voltage according to a predetermined priority order from the plurality of candidate voltages.

6. The LED device of claim 2, wherein the voltage selector selects a candidate voltage as the feedback voltage when only the candidate voltage is chosen by the voltage detection unit.

7. The LED device of claim 1 further comprising:
a reference generation unit, coupled to the error amplifier, for generating the reference voltage.

8. The LED device of claim 1, wherein each LED chain of the plurality of LED chains comprises a plurality of LEDs connected in series.

9. A control method for an LED device, the LED device comprising a plurality of LED chains, a current driving unit, and a voltage converter, each LED chain of the plurality of LED chains having a positive electrode and a negative electrode, the voltage converter coupled to the positive electrodes of the plurality of LED chains for converting an input voltage to an output voltage according to a voltage control signal, the current driving unit coupled to the negative electrodes of the plurality of LED chains for providing a plurality of driving currents to the plurality of LED chains, the control method comprising:
generating a plurality of candidate voltages according to a threshold voltage and a plurality of headroom voltages corresponding to the plurality of LED chains and selecting a feedback voltage from the plurality of candidate voltages;
generating an error voltage signal according to a reference voltage and the feedback voltage; and
generating the voltage control signal according to the error voltage signal to the voltage converter for voltage conversion.

10. The control method of claim 9, wherein the step of generating the plurality of candidate voltages according to the threshold voltage and the plurality of headroom voltages corresponding to the plurality of LED chains and selecting the feedback voltage from the plurality of candidate voltages comprises:
comparing the threshold voltage with the plurality of headroom voltages to select the plurality of candidate voltages being less than the threshold voltage from the plurality of headroom voltages; and
selecting the feedback voltage according to the plurality of candidate voltages.

11. The control method of claim 10, wherein the step of comparing the threshold voltage with the plurality of headroom voltages to select the plurality of candidate voltages being less than the threshold voltage from the plurality of headroom voltages comprises:
outputting a control signal when the corresponding headroom voltage is less than the threshold voltage; and
outputting the corresponding headroom voltage according to the control signal.

12. The control method of claim 10, wherein the step of selecting the feedback voltage according to the plurality of candidate voltages comprises selecting the feedback voltage in a random manner from the plurality of candidate voltages.

13. The control method of claim 10, wherein the step of selecting the feedback voltage according to the plurality of candidate voltages comprises selecting the feedback voltage according to a predetermined priority order from the plurality of candidate voltages.

14. The control method of claim 10, wherein the step of selecting the feedback voltage according to the plurality of candidate voltages comprises selecting a candidate voltage as the feedback voltage when only one candidate voltage is chosen.
